(19) United States
(12) Patent Application Publication
(10) Pub. No.: US 2014/0310030 A1
(43) Pub. Date: Oct. 16, 2014

(54) SYSTEM AND METHOD FOR PROCESSING ESTABLISHMENT RESERVATION

(71) Applicant: Kiran Cheranda, Torrance, CA (US)

(72) Inventor: Kiran Cheranda, Torrance, CA (US)

(73) Assignee: APPETIZ SOLUTIONS, INC., Torrance, CA (US)

(21) Appl. No.: 14/247,249

(22) Filed: Apr. 7, 2014

Related U.S. Application Data
(60) Provisional application No. 61/811,350, filed on Apr. 12, 2013.

(51) Int. Cl. G06Q 10/02; G06Q 50/12

(52) U.S. Cl. CPC G06Q 10/02; G06Q 50/12
USPC 705/5

(57) ABSTRACT

A method and system of making real time reservations at an establishment is provided. The system is GPS based, displaying relevant establishments proximate to the user, and offers the ability to post real time offers and advertising from an establishment to a user computing device. In one configuration, the system includes a server arrangement including at least one server configured to receive communications from a user device configured to enable a user to select an establishment and a remote device configured to receive information from the server arrangement pertaining to a reservation for the establishment and transmit indications to the user confirming the reservation. The server arrangement is configured to interact with an establishment device to determine establishment availability conditions for incoming patrons and convey establishment availability conditions to the user via the user device.

This application claims the benefit of U.S. Provisional Patent Application 61/811,350, “System and Method for Processing Establishment Reservations,” inventor Kiran Cheranda, filed Apr. 12, 2013, the entirety of which is incorporated herein by reference.

### BACKGROUND OF THE INVENTION

1. Field of the Invention

The present invention relates generally to processing reservations in real time, and more specifically to systems and methods for managing and coordinating reservations in real time in an establishment setting, such as a restaurant setting.

2. Description of the Related Art

Current reservation systems suffer from an inability to dynamically track and update information. In the restaurant setting, multiple tables are often available, where no one is dining at the establishment but no one outside the restaurant knows this information, or unavailable, where all tables are taken but again, no one outside the restaurant knows this. Seating usually occurs using a map of the restaurant beneath a sheet of clear plastic wherein the host or hostess marks off tables with a grease pencil as patrons are seated. Information about when diners leave is sometimes conveyed to the host or hostess, but this information can be inaccurate or slow to reach the desired personnel. Additionally, restaurants are unable to convey information such as present wait time, number of full tables, and so forth, and thus patrons are forced to visit the restaurant to determine how long they will need to wait before being seated. This can result in more business if, for example, a bar is available, but many restaurants do not have a bar, and certain patrons are uninterested in partaking of drinks at a bar and are forced to simply wait until a table is ready.

Virtually all restaurants will offer phone responses, such as when a patron calls the restaurant and asks how long the wait is. However, the information obtained can be inaccurate and is somewhat limited, and this service requires effort on the part of a host or hostess. Some restaurants have taken the step to offer a beeper or buzzer type device to patrons waiting for a table, but this is only offered after the patron has visited the restaurant and been told he or she will have to wait.

Many restaurants do not offer any type of solution to the unfilled table problem. If patrons are not eating at any particular time, the restaurant management has no ability to take any action other than to wait for patrons to arrive.

Restaurants are not the only establishments that have flow issues. Nightclubs, hair salons, bowling alleys, and various other establishments typically operate with a single point of contact where a patron must visit the physical location or telephone ahead to determine availability.

Certain types of scheduling programs and web sites pertaining to restaurants and similar establishments are available. One current web site allows patrons to make reservations at restaurants ahead of time, and patrons can find out that a restaurant has no tables available at a future date. However, such web sites are limited to restaurants where they have an agreement, and such programs or sites operate based on information provided by the restaurant, such as we can accommodate 45 parties, including 25 tables for 2, 10 tables for 3 or 4, and 3 tables that can accommodate 5 or 6, and 10 tables that can accommodate 6 or more. Certain patrons fail to honor their reservations, and the restaurant can be faced with a number of unavailable tables, even though the program or web site had indicated no tables were available. Further, many restaurants do not wish to offer reservations, and others may not wish to patronize or use these programs or web sites for one reason or another. Additionally, some restaurants can move tables or rearrange seating to accommodate different sized parties, and this information is generally unavailable on these types of web sites.

In light of the above, it would be advantageous to offer a design that improves the reservation process that offers a patron more information without having to visit the establishment, and that overcomes issues and limitations present in previous designs.

### SUMMARY OF THE INVENTION

According to one aspect of the present design, there is provided a system for processing reservations for at least one establishment. The system comprises a server arrangement comprising at least one server configured to receive communications from a user device configured to enable a user to select an establishment and a remote device configured to receive information from the server arrangement pertaining to a reservation for the establishment and transmit indications to the user confirming the reservation. The server arrangement is configured to interact with an establishment device to determine establishment availability conditions for incoming patrons and convey establishment availability conditions to the user via the user device.

According to another aspect of the present design, there is provided a method for making reservations at an establishment. Such a method includes receiving information from an establishment device regarding current establishment availability conditions, determining a notification to be provided to selected communication channels when establishment availability conditions exceed a predetermined value, and providing the notification to the selected communication channels and selected users in an attempt to persuade the users to visit the establishment. The predetermined establishment availability conditions may include the establishment being less than half full, or a value that is less than half full.

According to another aspect of the present design, there is provided an apparatus for making reservations at an establishment, comprising a user device comprising a processor configured to perform a method comprising searching for available establishments proximate the user device, enabling a user to select a desired establishment, obtaining information regarding current establishment availability conditions, transmitting a request for a reservation based on current establishment availability conditions, receiving approval of the request for the reservation based on approval by an entity associated with the establishment, and optionally being notified of a bonus for making an approved reservation.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 illustrates a computer system for use in accordance with one embodiment of the present establishment reservation design;

FIG. 2 shows a portion of the present design including certain user device functionality;

FIG. 3 illustrates a portion of the present design including reservation functionality for a particular establishment;

FIG. 4 represents a portion of the present design including establishment or restaurant dashboard functionality;

FIG. 5 is a portion of the present design including restaurant functionality;

FIG. 6 is a screen shot of a restaurant listing on a user device;

FIG. 7 is a screen shot of a reservation request page for a specific establishment as presented on a user device;

FIG. 8 shows a screen shot of a table representation in a restaurant used to enable the user to select a table at the restaurant for a reservation;

FIG. 9 illustrates a screen shot of a user device displaying information pertinent to the patron such as name, telephone number, and so forth;

FIG. 10 illustrates an administrator dashboard that may enable an administrator to execute administrative functions;

FIG. 11 illustrates an establishment (restaurant) dashboard that may be displayed on a computing device located at an establishment;

FIG. 12 shows an “edit table” screen wherein establishment personnel may be allowed to manage reservation times, table inventory, and set a loyalty reward count;

FIG. 13 shows an opt-in customer list wherein customers can opt in for email marketing;

FIG. 14 is an establishment transaction list where establishment personnel can view transactions, sort by customer name or time period, and export the data;

FIG. 15 is an establishment review list; and

FIG. 16 is a global offer list, where the establishment can post offers for customers to see on their computing devices.

The exemplification set out herein illustrates particular embodiments, and such exemplification is not intended to be construed as limiting in any manner.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

In general, the present design includes a system and method for dynamically reserving positions in real time and updating users on positions available without the need for each user to visit the establishment. Of particular note is that the system typically employs GPS (global positioning system) information to enable the user to find establishments in real time, such as restaurants, near him or her. The user when accessing the system is in most cases immediately presented with a listing of establishments in order of closest physical proximity to him or her based on GPS data.

Of further note in the present design, personnel from a particular establishment can immediately post offers in an attempt to develop interest in the establishment. For example, if a restaurant is slow on a Saturday afternoon, establishment personnel can readily employ the system to send out an offer of, for example, 10 percent off until 5:00 pm. Once entered, such an offer is conveyed to users depending on how each user has set up preferences for notification. As an example, such an offer may be sent directly to a user's smartphone. Such operation provides real time offering of benefits to the user and/or advertising for the establishment.

The present system and method also offers the user or patron an opportunity both make a reservation, potentially based on establishment occupancy or capacity conditions, for the establishment at a desired time, and an opportunity to receive information or promotional materials using a computing device such as a smartphone or tablet or other device. The present design affords an establishment an opportunity to offer promotions when an establishment has few patrons, such as being less than half full, where establishment personnel seek to have patrons visit the establishment at that time. The system typically comprises a server arrangement configured to obtain relatively current establishment capacity information from a source, such as the establishment, and convey that information to interested parties either through a web site, text, email, or other appropriate means, and again to potentially convey a promotion to interested parties or devices of interested parties or to web sites as directed by the establishment while allowing each user to make a reservation at an establishment of his or her choice.

Thus the present design includes a real time reservation system, dynamically updated and updatable, that typically employs GPS information to rapidly convey information to users and enable establishments to market availability.

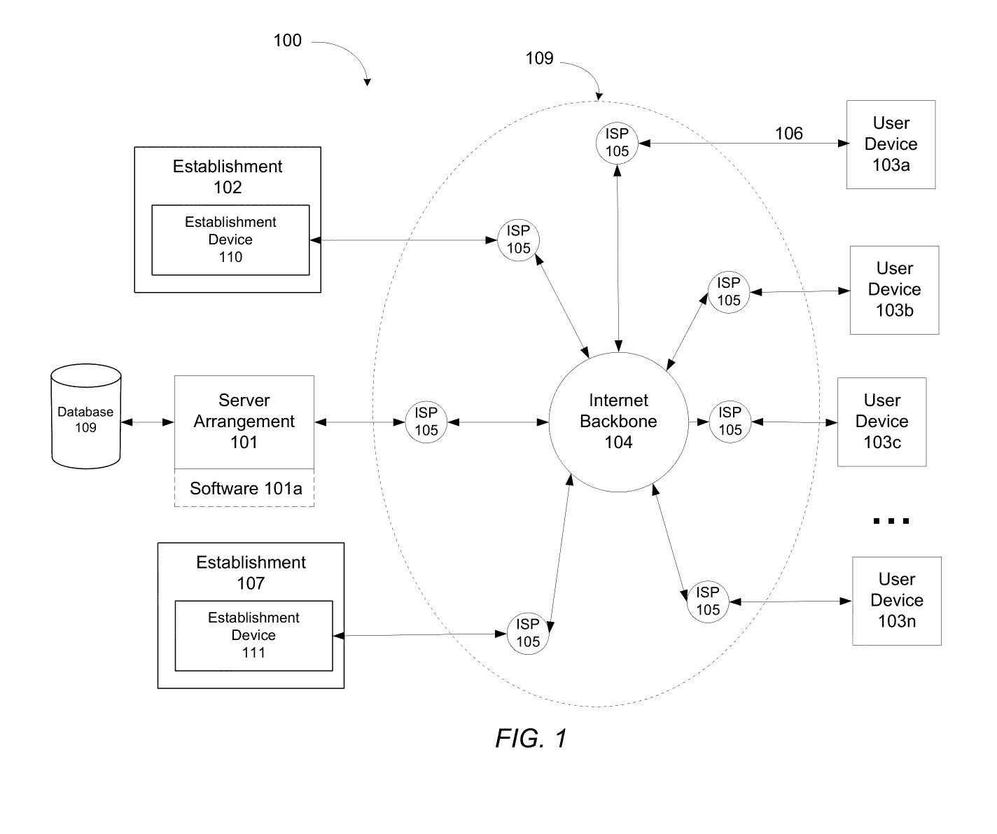

The present design is generally illustrated in FIG. 1. From FIG. 1, a computer system 100 includes a server arrangement 101 comprising software 101a, the server arrangement comprising at least one server and used generally for obtaining information related to at least one establishment 102 and conveying information about the establishment 102 to third party computing devices or user devices 103a-n such as personal computers, smartphones, tablets, or other devices. Each user device may connect to the Internet backbone 104 using an Internet service provider (ISP) 105. A fixed cable or an over-the-air wireless connection at 106 may support the communications between ISP 105 and the user device 103a. An application program, for example an Internet browser or other application, including a downloadable client software program, may provide a graphical or other user interface to the user, and may execute on a user device such as user device 103a providing access for the user to server arrangement 101. Note that multiple user devices may use a single ISP, and a one-to-one correspondence between user devices and ISPs is not required.

Server arrangement 101 may be a single server or group of servers, such as the “cloud,” or other arrangement of processing devices. A user account on server arrangement 101 may be activated or accessed by the user if applicable. Once created and activated, the user may provide authentication information, for example by entering a login name and password. The present design may provide Internet Protocol security and other data protection measures when accessing establishment systems or subsystems to provide secure communications channels. Some of the data protection methods may be distributed and implemented within communications network 108. In addition, the present design may be located in a secure data facility to further protect information of each establishment 102. Although two establishments, 102 and 107, and two establishment devices, 110 and 111, are illustrated in FIG. 1, it is to be understood that any number of establishments and establishment devices may employ and/or be employed in the current design.

The server arrangement 101 may interface with or include a database 109 that maintains information discussed herein. Much of the present design deals with functionality of server arrangement 101, establishment device(s) 110 and/or 111, and user device(s) 103. While described herein with respect to a restaurant establishment or establishments, it is to be understood that the present design may apply to any establishment seeking to manage flow of patrons, including but not limited to amusement parks, bowling alleys, hair and nail salons, nightclubs, and so forth.

In one aspect, the present design will employ global positioning system (GPS) information on the user's device 103 to determine the location of the user. In the restaurant situation, the user can choose a restaurant based on his or her location and can establish a radius and determine eating establishments or other appropriate/desired establishments within the vicinity. Once the user has selected an establishment, the user can obtain real time availability at the establishment, such as the number of tables available, length of wait, number of tables of particular seating available (e.g. tables for 2, tables for 3 or 4, etc.), and other pertinent information.

When the establishment is not busy, the establishment or a person associated with the establishment can provide information indicating a promotion is to be provided to certain customers according to a set of rules, such as “when the restaurant is lower than 50 percent capacity, provide an email or text blast that gives interested parties 20 percent off if they arrive within the next hour.” Promotions may be provided based on input from a party associated with the establishment or from the server arrangement according to a set of rules and based on customer data and indicated desires. Promotions may be provided by the establishment; for example, a restaurant can post or identify Global Offers from a device at the restaurant, such as via a Restaurant Dashboard as described herein. Posting of such a promotion enables the restaurant to be listed under “OFFER” on the front page of the application provided to the user device. In other words, if such a promotion is transmitted, and the user selects “OFFER” rather than a zip code or restaurant name, the restaurant offering the promotion may be displayed to the user.

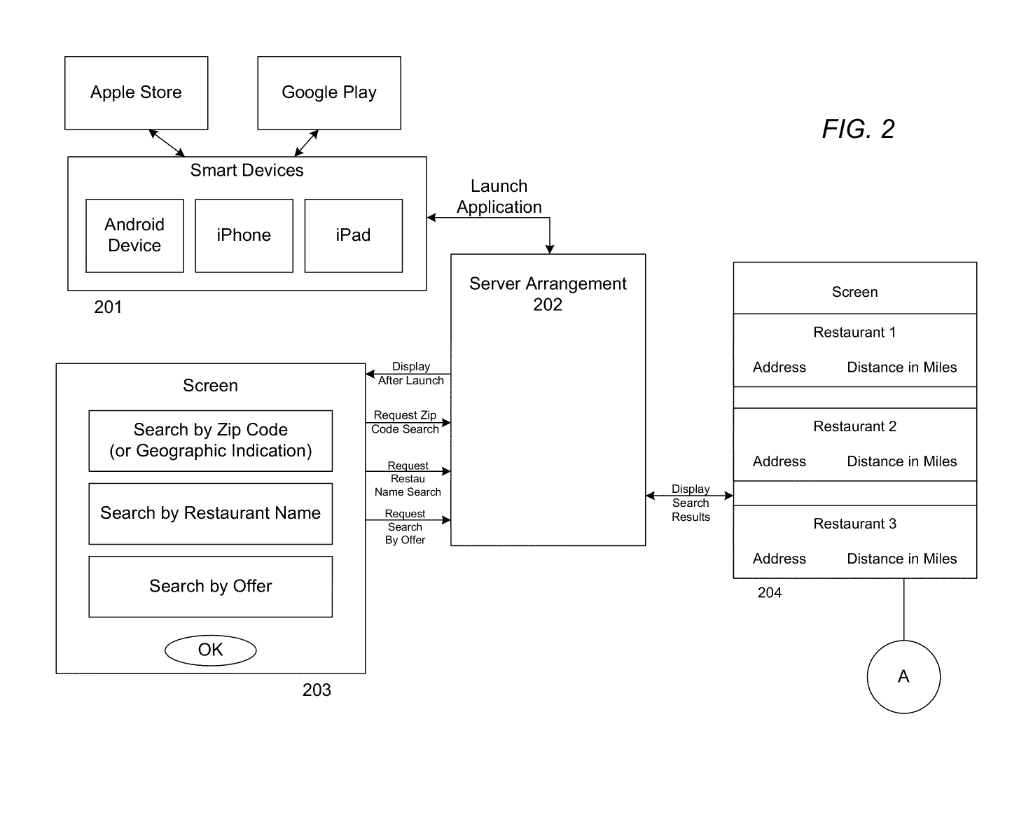

An overall representation of the functionality of the present design is presented in FIGS. 2-5. From FIG. 2, computing device 201, such as a smartphone (Android phone, iPhone, iPad, or other device) may obtain an establishment reservation application from an application source, e.g. the Apple store or Google Play. The device may launch the establishment reservation application, at which point the computing device 201 is connected to server arrangement 202. The server arrangement 202 provides a display to the computing device as shown by display 203, wherein the user is queried as to whether he or she wishes to search by zip code, restaurant name, restaurant offer, or some other value. The user's entry is then transmitted by the computing device 201 to server arrangement 202. The server arrangement in response provides the appropriate information and the information is displayed via a screen such as screen 204, listing restaurants, such as in order of nearest to farthest, by name with distance from each restaurant, and/or restaurant offers in a desired format, such as highest dollar value or percentage off, offers expiring soonest, or by a method entered by the user according to user criteria (e.g. pizza restaurants first, all others by largest percentage off).

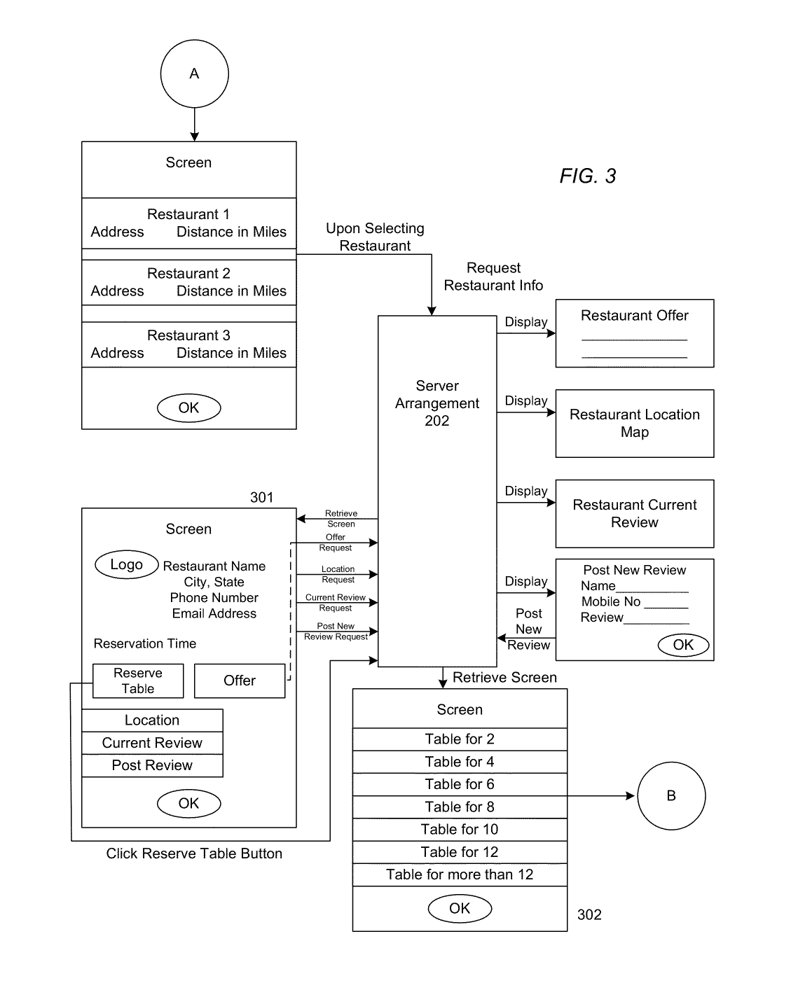

FIG. 3 again shows screen 204, and the system enables the user to select a particular establishment from those listed. This is translated in the computing device to a request for further information about the establishment selected. Server arrangement 202 takes this request and processes the request, transmitting an indication and instruction for the computing device to display a second screen 301, where the second screen 301 may include information about the establishment (name, address, telephone number, logo, and so forth) and may include options to, in the case of a restaurant, “reserve a table” or select an “offer.” A reservation time may also be displayed as shown, e.g. Wednesday April 24 at 7:30 p.m. The user may also be offered selections such as “location,” “current review” “post new review” wherein each of these choices offer, respectively, further information about the location, a review of the restaurant, or an ability to post a review of the restaurant, either with the server arrangement, establishment, or via a reviewing service. In one aspect, only those patrons known to the restaurant, such as having his or her information known to the restaurant or available through affiliates, etc. are able to post a review. When any of these options in second screen 301 is selected, the selection is transmitted to server arrangement 202, and as shown at point 302, the server arrangement 202 provides the requested information to the computing device 201. A restaurant offer may be displayed, in addition to restaurant location information, possibly including a map of the location, a restaurant review or reviews, and a screen configured to receive a user review may be offered by the server arrangement 202. As shown, a new review may be provided to the server arrangement 202.

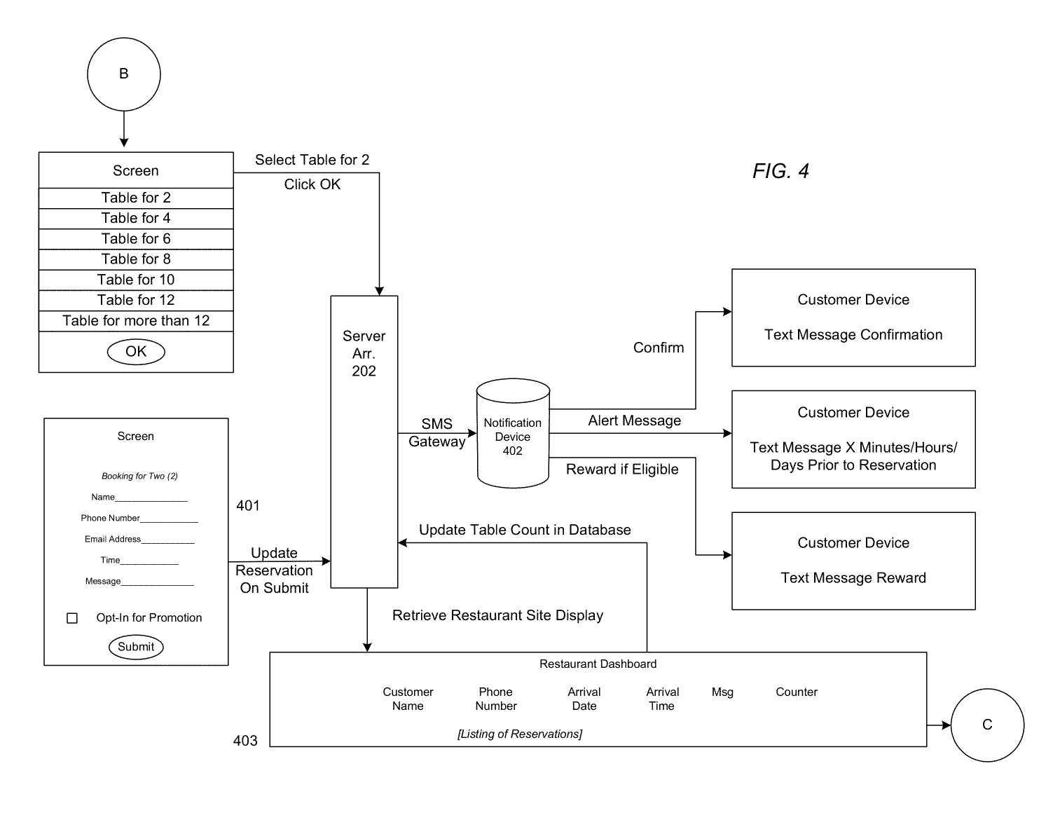

If the option to reserve a table is selected, the user may be presented with a screen similar in functionality to that shown as screen 302. The user may be offered an option to select table size—typically even numbers such as 2, 4, 6, 8, etc, but may be presented in different ways to users to ensure their parties are accommodated, e.g. 2, 3 or 4, 5 or 6, 7 or 8, and so forth. The user may make a selection, and the table selection is then transmitted to server arrangement 202 as shown in FIG. 4. From FIG. 4, if such a table is available, the user is presented with screen 401, wherein he is either asked to fill in information or if he or she is known to the system, the system populates the fields with relevant information. As an example, the user's name, contact information (mobile number, email address, etc.), may be provided by the user or filled in if the user is known to the system and the user has provided such information. Information about the requested reservation may be provided—time, and a message such as “two adults and two children,” “request seat near the window,” etc. may be provided by the user. In the case of time of the reservation, the user may be provided with limited options or may request a specific time. If requested, the information is transmitted to the server arrangement 202 and a confirmation may be received. In some embodiments, a denial may be received. However, in typical situations, a table or table size that is unavailable may not be offered to the user. In this scenario, tables can only be selected for reservation when available. When the tables are not available, an indication may be provided, such as the graphic image of the table greyed out with the message “Currently Unavailable”. The inventory of the tables in the database is reduced each time the tables are reserved and when the table inventory count reaches ‘zero’ that size table becomes unavailable. Additionally, the user may be offered the option to opt in to receive further information, and information about opting in may be provided to the user (e.g. receive alerts for this establishment, receive information for establishments in your area, receive information about a loyalty program, and so forth).

The information provided may then be transmitted by the server arrangement 202 to a computing device or processing arrangement 402, such as a separate third party device via an applicable transmission means, such as an SMS gateway, that provides information to the user in an appropriate format. Computing device or processing arrangement 402 may be instructed by server arrangement 202 to transmit a confirmation to the user's device. Such transmission may be commanded once the user's information is received, such as the information shown in screen 401 being received, or if verification by the establishment is required, once that confirmation is received, or at a desired time afterward. Alternately, or in addition, the user may be sent reminders, again via email, SMS, or other appropriate messaging medium. The user may also be advised by computing device or processing arrangement 402 that he or she is eligible for some type of bonus or reward, such as when the user has made a certain number of reservations at a location, he or she may be sent an email or text that he or she is eligible to eat for free from noon to 2:00 on Thursday, or is eligible to join a loyalty program and receive 1000 points. In a typical scenario, the user may be known to the establishment, and when she visits the establishment a given number of times, such as six times, she receives a bonus determined by the establishment. The system may keep track of visits and count down to zero or count up to the required number. Thus computing device or processing arrangement 402 operates as a messaging platform, transmitting messages to the user using an appropriate medium based on the reservation(s) he or she has made.

During these transactions, including the reservation transaction, the server arrangement 202 is also communicating with the establishment, such as by transmitting the various reservation requests received and storing those reservations locally if desired and/or requesting confirmation of the reservation. In one example, a party may wish to have a table for six in 20 minutes. If such a table is available, the establishment device may transmit acceptance back to the server arrangement 202. Element 403 represents a “restaurant dashboard,” namely a control panel for managing the incoming reservations and assisting establishment employees in managing customer flow. Element 403 may list information about the reservation, including date, time, name of the party, table size, and any other pertinent information. If the reservation request is approved, a release button may be provided that is engageable by establishment personnel, and alternately the device may evaluate current and future availability and provide approval according to established rules. Pressing the “release” button removes the reservation from the restaurant screen. Restaurant personnel may select “Release” once the customer has completed dining and leaves the restaurant. This “Release” updates the table inventory on the database and as a result increases the table count to adjust the table inventory that was reduced when the table was booked.

Confirmation of the reservation is transmitted to the server arrangement 402 and confirmation may be transmitted by the system to the patron in any acceptable manner With respect to restaurant rules, as an example, a restaurant may have a policy to keep at least one table open at all times in case certain persons, such as the owner, wishes to be seated, and thus when the number of tables is down to one remaining, the restaurant device or the system may automatically deny any further reservation requests.

It is to be understood that the present design may require added effort on the part of the personnel at the establishment. It can be extremely beneficial if the personnel indicate when seats are filled and vacated such that this information may be provided to the system and an accurate count of existing seats or tables be available to users and to the system. Determination of current capacity may be monitored by personnel or any other means available. As an example, sensors may be provided indicating when tables are filled and not filled, or devices provided on the table, such as RFID devices, that are returned to a central location when the party leaves, and position of the device measured. For example, device number 16 may be placed on table 57 when the party of four is seated and returned to a hostess station by establishment personnel when the party leaves table 57.

Each restaurant has its table inventory defined and the restaurant can change the table inventory from their restaurant dashboard at any time. Each time a reservation is made, the inventory count of that table is reduced on the database. When restaurant personnel select “Release” from the dashboard (after the customer completes their dining and leaves the table), the inventory count of that table is adjusted to reinsert that table into the list of available tables in the restaurant. It can therefore be beneficial for restaurant personnel to accurately manage this function to maintain an updated count of table inventory.

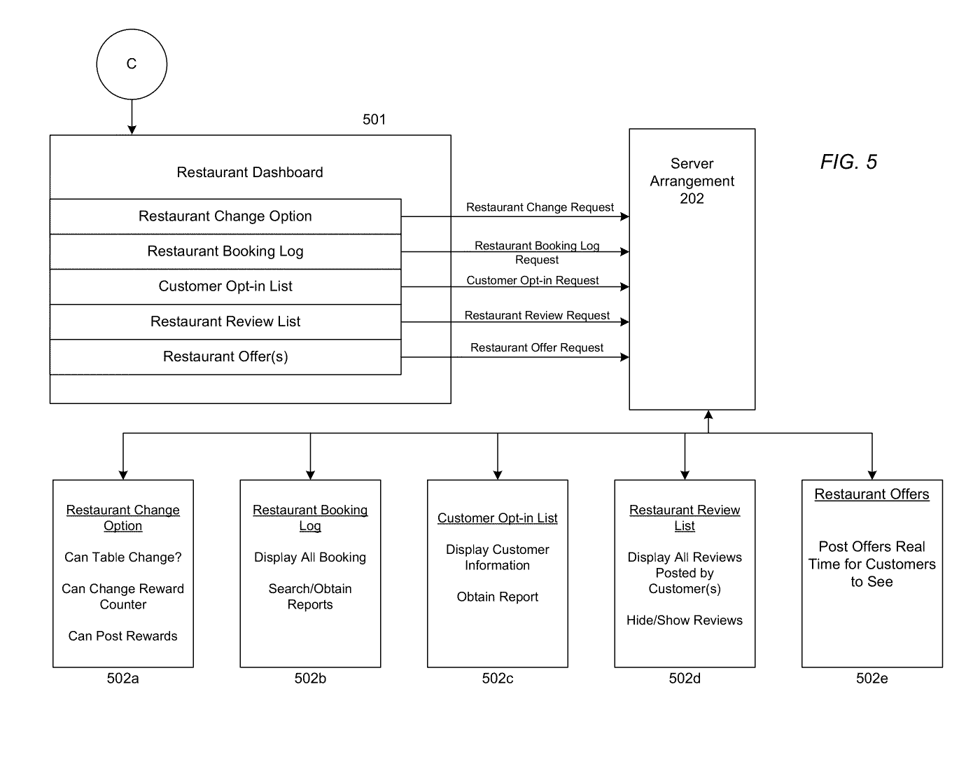

FIG. 5 illustrates the general functionality of the on-site work station, typically deployed at the establishment. From FIG. 5, server arrangement 202 may receive information from the customer dashboard 501, including restaurant change requests, where the restaurant desires to change a reservation, a restaurant booking log, which may be maintained at the restaurant or at the server arrangement 202 or at some other device, where the restaurant booking log includes all current reservations, information about patrons, and information about available tables in view of any restrictions placed on the restaurant. A customer opt-in list may also be maintained, where the customer who has opted in to certain offers can be identified and information disseminated or offers transmitted or even awarded to the patron when he or she visits the restaurant. Customer dashboard 501 may also maintain a list of restaurant reviews and a list of restaurant offers. These items may be provided from the customer dashboard to the server arrangement 202, and made available to patrons and potential patrons as desired. With respect to offers, any type of offer may be provided, including offers when the restaurant is slow and more business is desired. The restaurant may provide a limited time offer via email or text messaging. Restaurant reviews may be collected and made available to patrons such that the restaurant can screen reviews.

Boxes 502a-e enable retrieving and updating of information to and from the server arrangement 202. Function 502a provides for restaurant change options, such as table changes (number, configuration, availability, etc.), reward counter change (takes more or fewer visits to earn a reward, change of reward from one to another) and posting of rewards (customer X has earned reward number 2, and so forth). Function 502b is the restaurant booking function, enabling display of all booking and an ability to search and run reports. Function 502c is the customer opt-in list, wherein the restaurant can display customer information, and an ability to run a report for marketing purposes. For example, customer J may have opted in to receiving emails and texts from restaurant chain Z and restaurant K, and receive coupons from restaurant chain Z and restaurants B, F, L, and R, and to receive only discounts in excess of 10 percent from restaurants K and P and restaurant chain Q. All opt-in information is maintained and functionality to employ and deploy information to appropriate patrons is accomplished by the server arrangement.

Function 502d is restaurant review list, including a all reviews, posted by customers or critics, and such reviews may be selected for transmission when potential patrons request review information. Function 502e is the restaurant offers, where such offers are conveyed and made available in real time.

Thus according to the present design, there is provided a restaurant or establishment online reservation system wherein an application may be obtained by any reasonable means, including downloaded from an application source. Once a computing devices launches the application, a request is sent to a program running on the server arrangement and a display is provided including a Search box that requests a zip code or other geographic designation or restaurant name. The screen also has the option to search by a restaurant's offers or offers made by multiple restaurants. A database, typically located at the server arrangement, has participating restaurants information such as name, address, phone, fax, latitude, longitude, table inventory, global offer, reward offer, reward counter, and so forth.

Once the user enters a ‘zip code’ in the search box, the user's computing device sends a request to the server arrangement to search by zip code or other geographic information. The server arrangement searches for all the restaurants with that zip code, for example, in the database, retrieves restaurant name and address information and compares with the global defined field of ‘X’ miles (e.g. 5, 10, 15, 25 miles, etc.). The system may sort restaurants from closest to farthest within an ‘X’ mile radius of the user's current location, and the list may include the distance in miles from the user's current location.

Once the user enters the ‘restaurant name’ in the search box, a request to search by restaurant name is sent to the server arrangement. The server arrangement searches for all the restaurants with that restaurant name in the database, retrieves restaurant name and address information and compares with the global defined field of ‘X’ miles (can be 10, 15, 25 . . . ) to sort restaurant from closest to farthest within ‘X’ miles of the user's current location. This restaurant name may be displayed on the user's device screen with distance in miles.

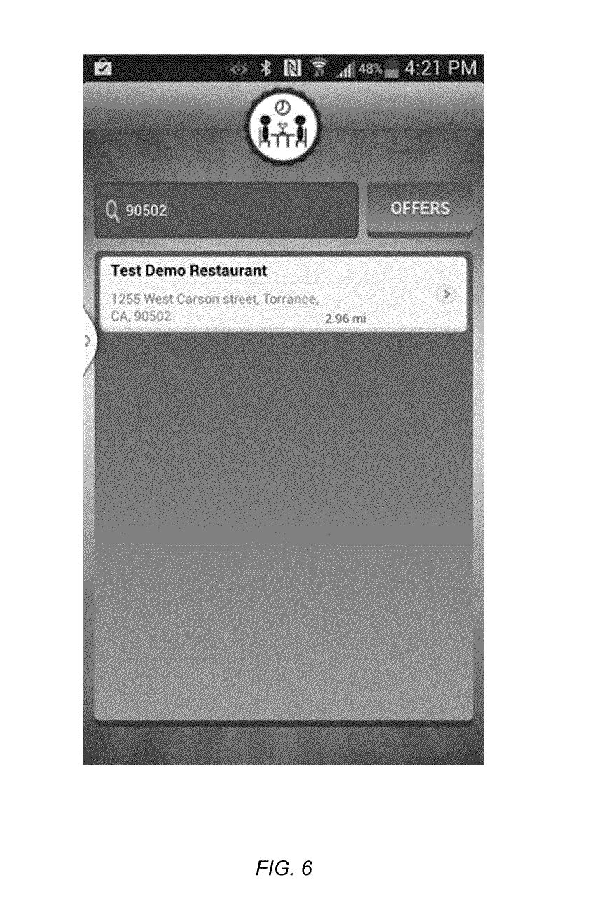

If the user pushes ‘OFFER’ to search, the user's device sends a request to search by restaurants providing offers. The server arrangement searches for all restaurants with offers in the database, retrieves restaurant name and address information, and compares the offers with the user's position and potentially the global defined field of the ‘X’ mile radius. The server arrangement may sort the offers in any desired manner, such as by amount of discount, alphabetically, or from closest to farthest within the ‘X’ mile radius of the user's current location. FIG. 6 illustrates a screen having a distance in miles provided.

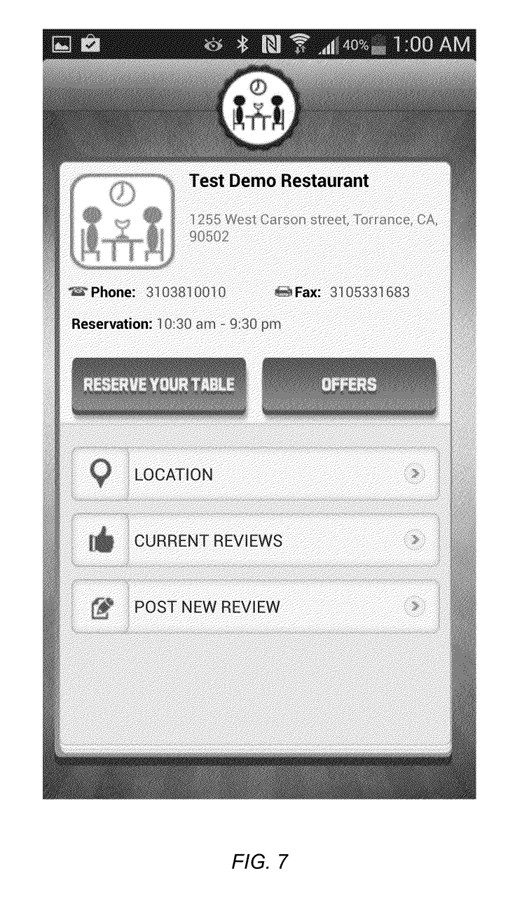

Upon selecting a restaurant from the list, the user device transmits a request to the server arrangement to retrieve, for example, the restaurant logo, restaurant, address, city, state, zip, phone, fax, opening time, and so forth. All or part of these elements may be displayed, and one example of a display is shown in FIG. 7. The screen may also present to the user various options such as ‘RESERVE YOUR TABLE’, ‘OFFERS’, ‘LOCATION’, ‘CURRENT REVIEW’, ‘POST NEW REVIEW’, and so forth.

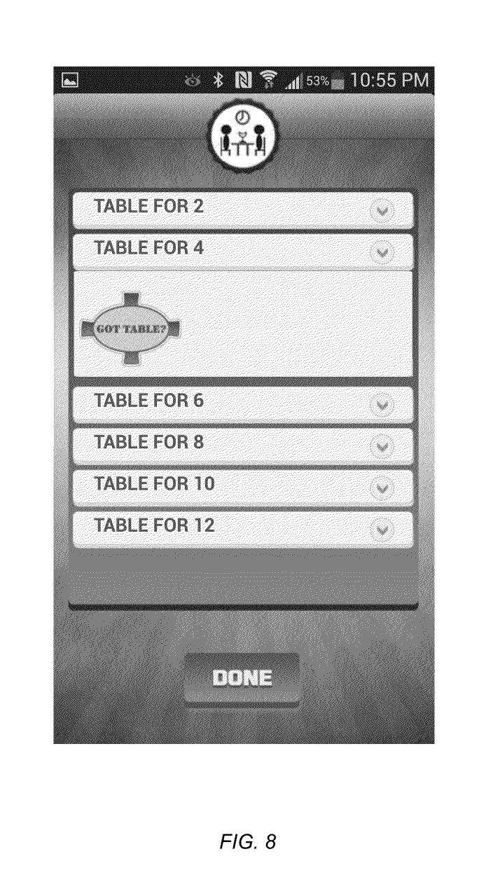

Of particular note in FIGS. 6 and 7 are the “OFFER” buttons, intended to provide real time offers to potential patrons. If the user selects ‘OFFERS,’ the user's device transmits a request to retrieve an offer or offers from the server arrangement. The server arrangement then retrieves appropriate offers from the database and displays them on the user device screen, e.g. “$2 off an entree for the next three hours.” When the user selects ‘LOCATION’ the user device sends a request to the server arrangement to retrieve a pull map for that restaurant. The server arrangement retrieves the map and provides the map for display on the screen of the user's device. When the user selects ‘CURRENT REVIEW’ the user device sends a request to retrieve all or some existing reviews for that restaurant. The server arrangement retrieves existing appropriate reviews from the database and provides them to the user device. When the user selects ‘POST NEW REVIEW,’ the user device transmits a request to the server arrangement. The server arrangement may request information such as name, mobile telephone number or email address, and the review. Upon entering the requested information and completing the data entry, e.g. by pressing “OK” or some other indicator, the user's device sends the request to the server arrangement. The server arrangement checks for validation and accepts the review. The server arrangement may function to receive the review only if the customer name and mobile telephone number or other identifying information exists on the database. When the user selects ‘RESERVE TABLE,’ the user device transmits a request to the server arrangement, and the server arrangement may retrieve table layout for that restaurant and display the information such as is shown in FIG. 8.

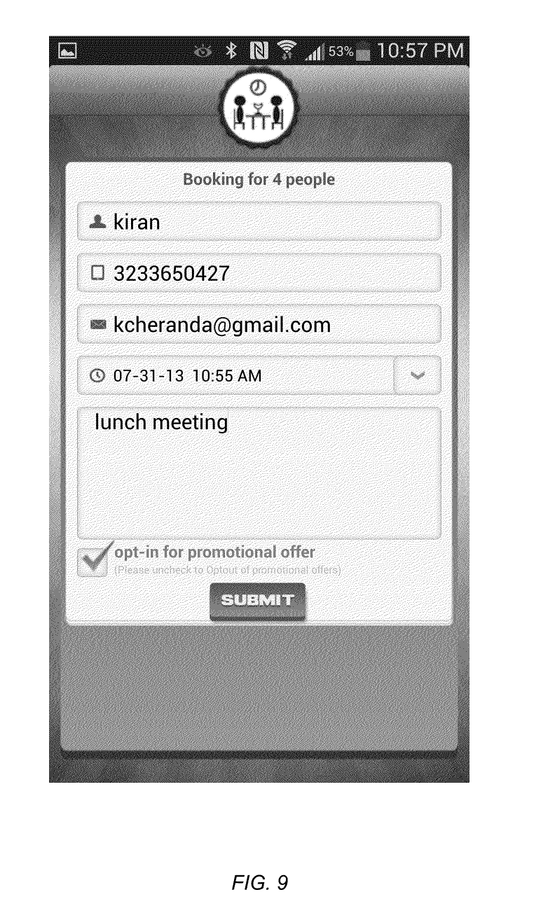

Upon selecting a ‘TABLE FOR 4’ as shown in FIG. 8, and selecting ‘DONE,’ the user's device transmits the reservation request for the particular size of table to the server arrangement. The server arrangement may transmit, or the user's device may offer, information requests including a request for information such as ‘NAME’ MOBILE NO′‘EMAIL ADDRESS’ ‘TIME’ ‘MESSAGE’ ‘Opt-in for Promotional Offers’ or other appropriate information. One example of such information is presented in FIG. 9.

The user may enter ‘NAME’ ‘MOBILE NO’ ‘EMAIL ADDRESS’ ‘TIME’ ‘MESSAGE’ and may ‘Opt-in for Promotional Offers.’ The user may select ‘SUBMIT’ and may update the entry on the database and adjust the table inventory for a table for four in this example. The server arrangement may provide an indication to a computing device, such as a device maintained by a third party, to transmit an SMS message to the user confirming the reservation of the table.

The system may then check the customer's number of visits counter against a reward counter. If the count matches or exceeds the reward counter, the server arrangement may contact the device or otherwise may transmit an indication, such as an SMS message, indicating a ‘reward’ or ‘reward offer’ for the user. The server arrangement may also function at a given time, such as ‘X’ minutes before the scheduled reservation time, to send an email or SMS alert message or other indication of ‘Table Reservation at time booked.’

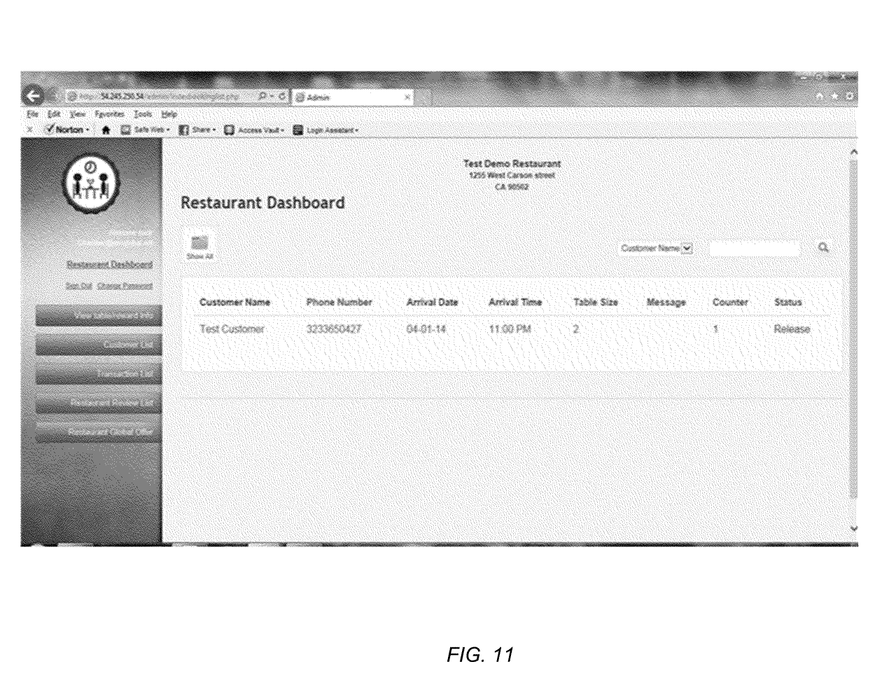

Once the reservation is complete and confirmed, the server arrangement sends the reservation information to the restaurant. The restaurant dashboard then displays on the queue customer name, phone, arrival date, arrival time, message, counter and may include a “RELEASE” or similar option. FIG. 11 illustrates an establishment/restaurant dashboard, where on the right side under “status,” the establishment personnel may select “Release” to release a reservation.

The restaurant can determine when the customer is to receive a reward offer or has exceeded a number of visit count, whereupon the user may be sent a promotion, such as by sending the patron an SMS message or email notifying him or her of the promotion or sending the promotion via SMS or email, or the patron may receive a promotion when he or she visits the restaurant. Once the patron completes his or her dining, the restaurant releases that reservation by selecting ‘Release,’ whereupon the entry drops off the screen. The restaurant device then sends a request to the server arrangement to adjust table inventory. This completes a table reservation cycle.

The restaurant dashboard, shown in FIG. 11, is available on a computing device including a processor set up for each restaurant with Site Admin access. Through this dashboard, restaurant personnel can adjust the table inventory, change the count for reward, post an offer for reward, or provide other functionality related to reservations and promotions. Restaurant personnel can view and prepare a report of the customer list and opt-in selections for the customers for marketing purposes. The establishment personnel can also view and obtain a report of the booking log, view one customer review or multiple customer reviews, and can decide certain reviews will not be made available. Restaurant personnel using the restaurant device can also post an offer as global offer that causes the server arrangement and any other necessary transmission devices to send offers for customers to view, either unprompted or when the customer searches for restaurants with offers.

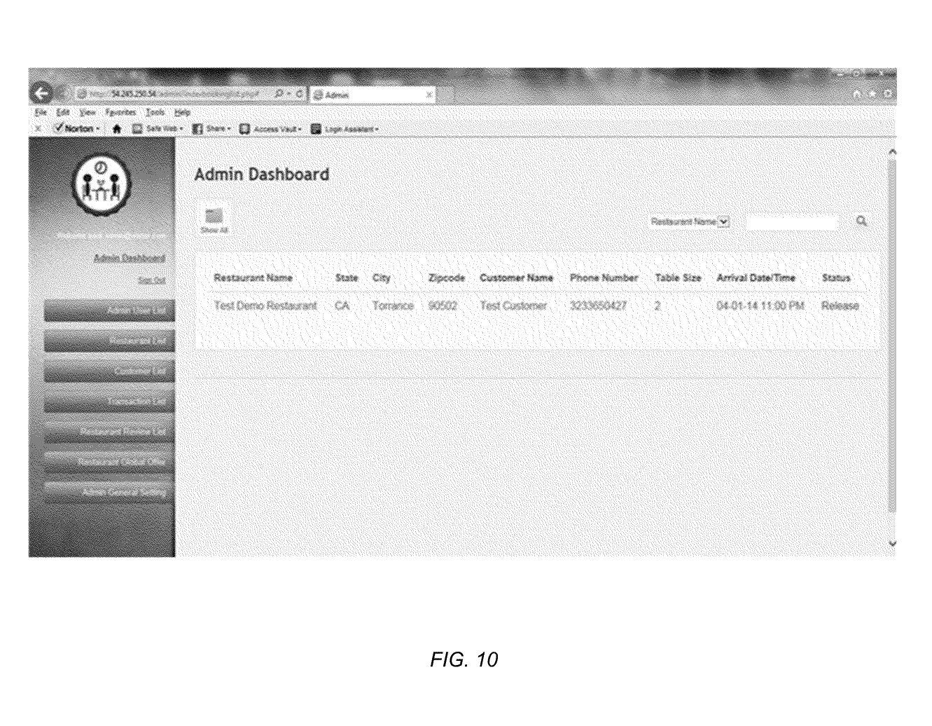

The system may also provide a Super Admin panel, shown in FIG. 10, used to load establishments such as restaurants into the system. The panel can establish user access for restaurants and typically includes all the features described with respect to the restaurant dashboard. This panel may also offer an ability to provide global settings, such as defining for all users an ‘X’ mile radius for restaurant search results. Such functionality can limit the risk of excessive search results. This Super Admin panel controls all restaurants employing the system and can obtain reports or run queries for a particular restaurant or group of restaurants.

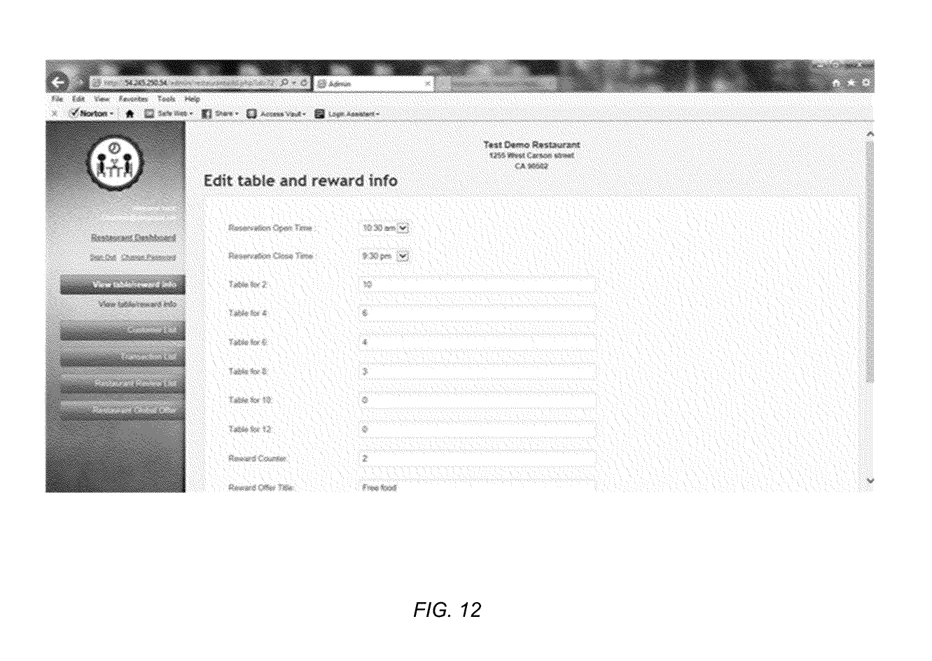

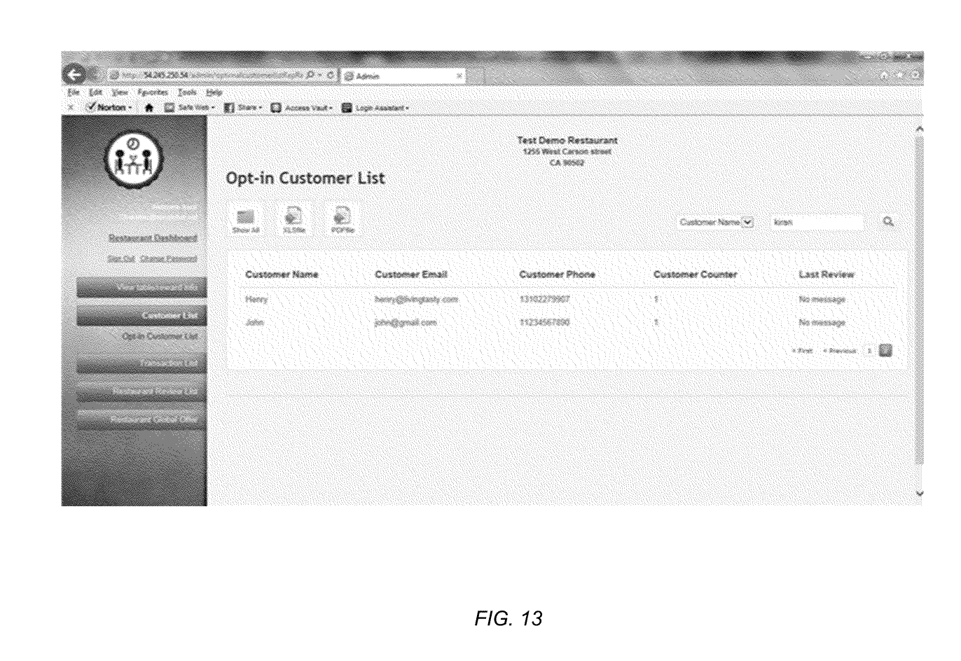

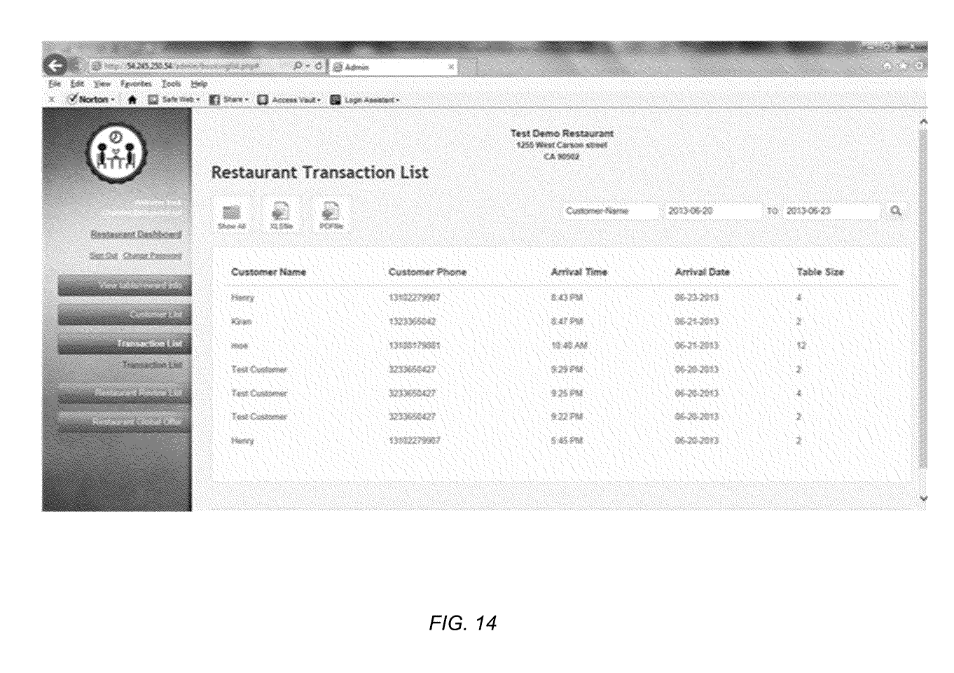

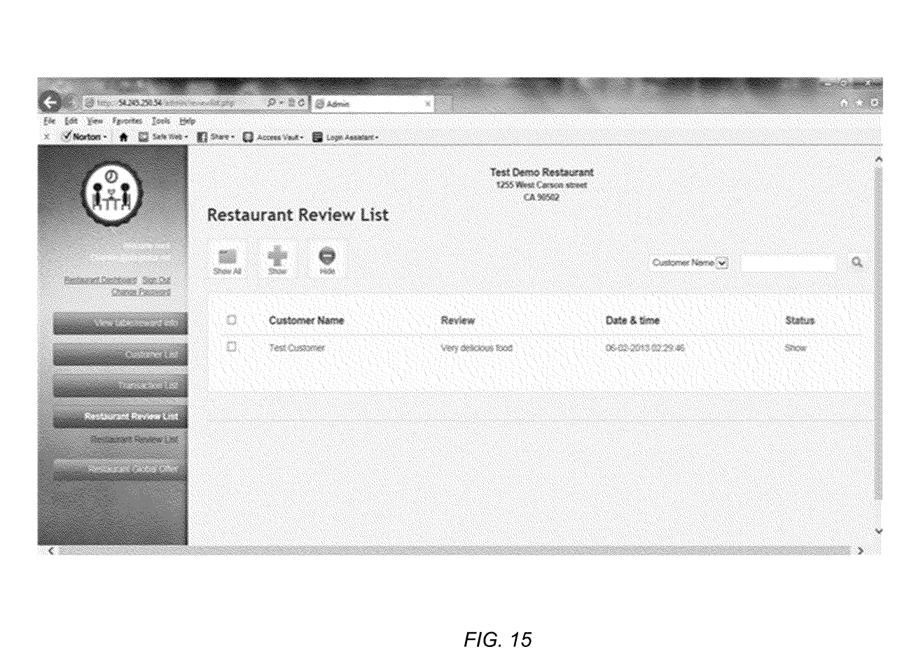

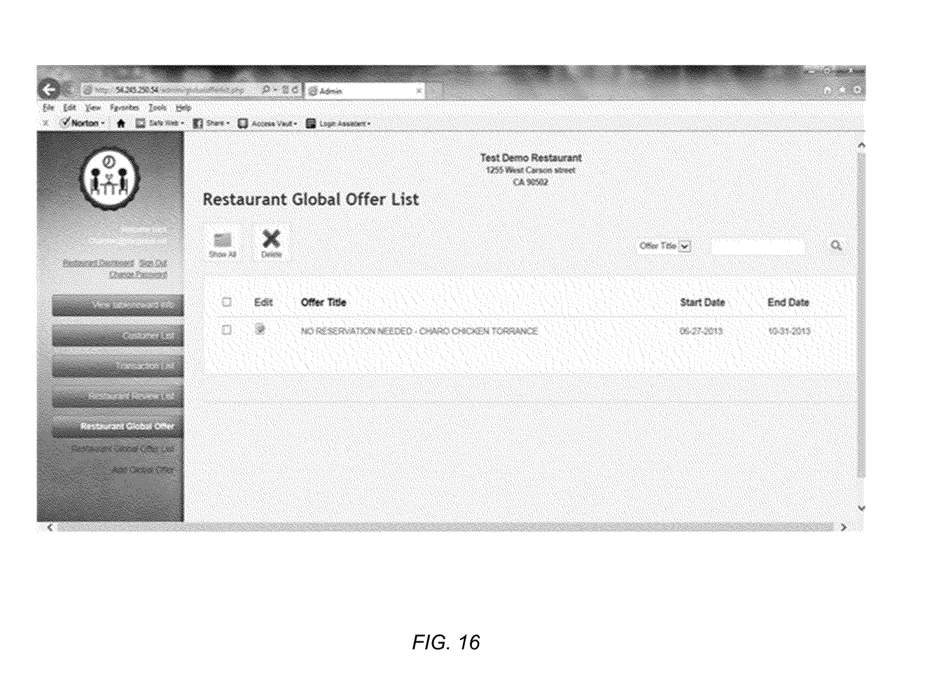

Additional establishment functionality may be provided as shown in FIGS. 12-16. FIG. 12 shows a screen wherein establishment personnel may be allowed to manage reservation times, table inventory, and set a loyalty reward count. FIG. 13 shows an opt-in customer list wherein customers can opt in for email marketing, and the list can be exported to an appropriate format, e.g. spreadsheet or pdf. FIG. 14 is an establishment transaction list where establishment personnel can view transactions, sort by customer name or time period, and export the data. FIG. 15 is an establishment review list, where the establishment can view reviews by customers and can hide reviews if desired. FIG. 16 is a global offer list, where the establishment can post offers for customers to see on their computing devices. The establishment can control offers by altering the end date.

Thus the present design also includes a GPS enable search result that populates restaurants from nearest to farthest of the customer physical location within a defined radius. A potential patron can view, in real time, the table availability for a selected restaurant. The restaurant can push offers to bring customers to their establishment. Patrons can benefit almost instantly from the offers made by the establishment. Patrons can be rewarded for loyalty via tracking of visits to one or more establishments. The restaurant dashboard allows restaurants to monitor and manage customer table reservations, push offers, update table inventory, and provide a reward counter and reward offers. The restaurant dashboard allows restaurant or establishment to produce reports by customer transaction and opt-in customer information marketing purposes.

The present design provides GPS enabled functionality to search restaurants or establishments by zip code, restaurant name and offers. Patrons and potential patrons can view, in real time or near real time, the table availability for a selected restaurant. The automated reserve table function can eliminate human errors and give customers control over a dining experience without visiting the establishment. Rewards can be provided, such as for loyalty, and such rewards can be provided in a number of different ways—email, text, etc.—at the time of reserving a table. The restaurant can push offers and promote new products to attract customers. Customer opt-in information may be proprietary to that restaurant or to a single entity and can be used for marketing purposes.

As an example, the system may enroll EXYZ restaurant in Santa Monica to our system. The system gathers details of the establishment such as address, city, zip, state, latitude, longitude, and table layout inventory. Information may be loaded into a central database, such as a database maintained within a server arrangement, via the Administrator or Super Admin Dashboard. User access may be provided at the establishment on one or more establishment devices, such as a single restaurant implementation at EXYZ restaurant.

Diners who download the application to their user device can launch the program and obtain EXYZ restaurant from the search and reserve a table. Similarly, the restaurant can use its dashboard to view customer reservation queues, post offers, approve reservations, and so forth.

Thus according to the present design, there is provided a system for processing reservations for at least one establishment. The system comprises a server arrangement comprising at least one server configured to receive communications from a user device configured to enable a user to select an establishment and a remote device configured to receive information from the server arrangement pertaining to a reservation for the establishment and transmit indications to the user confirming the reservation. The server arrangement is configured to interact with an establishment device to determine establishment availability conditions for incoming patrons and convey establishment availability conditions to the user via the user device.

Alternately, the present design may include a method for making reservations at an establishment. Such a method includes receiving information from an establishment device regarding current establishment availability conditions, determining a notification to be provided to selected communication channels when establishment availability conditions exceed a predetermined value, and providing the notification to the selected communication channels and selected users in an attempt to persuade the users to visit the establishment. The predetermined establishment availability conditions may include the establishment being less than half full, or a value that is less than half full.

The design may also include an apparatus for making reservations at an establishment, comprising a user device comprising a processor configured to perform a method comprising searching for available establishments proximate the user device, enabling a user to select a desired establishment, obtaining information regarding current establishment availability conditions, transmitting a request for a reservation based on current establishment availability conditions, receiving approval of the request for the reservation based on approval by an entity associated with the establishment, and optionally being notified of a bonus for making an approved reservation.

The devices, processes and features described herein are not exclusive of other devices, processes and features, and variations and additions may be implemented in accordance with the particular objectives to be achieved. For example, devices and processes as described herein may be integrated or interoperable with other devices and processes not described herein to provide further combinations of features, to operate concurrently within the same devices, or to serve other purposes. Thus it should be understood that the embodiments illustrated in the figures and described above are offered by way of example only. The invention is not limited to a particular embodiment, but extends to various modifications, combinations, and permutations that fall within the scope of the claims and their equivalents.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A system for processing reservations for at least one establishment, comprising:
a server arrangement comprising at least one server configured to receive communications from a user device configured to enable a user to select an establishment; and
a remote device configured to receive information from the server arrangement pertaining to a reservation for the establishment and transmit indications to the user confirming the reservation;
wherein the server arrangement is configured to interact with an establishment device to determine establishment availability conditions for incoming patrons and convey establishment availability conditions to the user via the user device.

2. A method for making reservations at an establishment, comprising:
receiving information from an establishment device regarding current establishment availability conditions;
determining a notification to be provided to selected communication channels when establishment availability conditions exceed a predetermined value;
providing the notification to the selected communication channels and selected users in an attempt to persuade the users to visit the establishment.

3. The method of claim 2, wherein the predetermined establishment availability conditions comprise the establishment being less than half full.

4. The method of claim 2, wherein the predetermined establishment availability conditions comprise a value that is less than half full.

5. An apparatus for making reservations at an establishment, comprising:
a user device comprising a processor configured to perform a method comprising:
searching for available establishments proximate the user device;
enabling a user to select a desired establishment;
obtaining information regarding current establishment availability conditions;
transmitting a request for a reservation based on current establishment availability conditions;
receiving approval of the request for the reservation based on approval by an entity associated with the establishment; and
optionally being notified of a bonus for making an approved reservation.
